(19) United States
(12) Patent Application Publication
(10) Pub. No.: US 2005/0011046 A1
(43) Pub. Date: Jan. 20, 2005

(54) Self closing and locking hinge

(76) Inventor: Ara Dionysian, Los Angeles, CA (US)

Correspondence Address: CISLO & THOMAS, LLP, 233 WILSHIRE BLVD, SUITE 900, SANTA MONICA, CA, 90401-1211, US

(21) Appl. No.: 10/621,487

(22) Filed: Jul. 16, 2003

(51) Int. Cl. E05F 1/02

(52) U.S. Cl. 16/316

(57) ABSTRACT

Provided is a self-closing hinge system, including a first member, and a second member rotationally coupled to the first member, wherein the first and second members each include an oblique edge abutting each other, such that a horizontal force on one of the members is translated into a horizontal and vertical force.

### BACKGROUND

There may have been many attempts to provide a self-closing hinge for doors, gates, and the like. Problems with current configurations may include complexity, cost, ease of installation, and ease of assembly and disassembly. What is needed is a low-cost, low complexity self-closing hinge that is easy to install and easy to assemble and disassemble.

### SUMMARY

Provided is a self-closing hinge system, including a first member, and a second member rotationally coupled to the first member, wherein the first and second members each include an oblique edge abutting each other, such that a horizontal force on one of the members is translated into a horizontal and vertical force.

### BRIEF DESCRIPTION OF THE DRAWINGS

FIG. 1 is a perspective view of an exemplary embodiment of a hinge, showing the hinge in the open position.

FIG. 2 is a perspective view of the exemplary embodiment shown in FIG. 1, with one of the leaf members uncoupled from the other.

FIG. 3 is a perspective view of another exemplary embodiment.

FIG. 4 is a perspective view of yet another exemplary embodiment.

FIG. 5 is a perspective view of the exemplary embodiment shown in FIG. 4, with one of the leaf members uncoupled from the other.

### DETAILED DESCRIPTION

The detailed description set forth below in connection with the appended drawings is intended as a description of exemplary embodiments and is not intended to represent the only forms in which the embodiments may be constructed and/or utilized. The description also sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

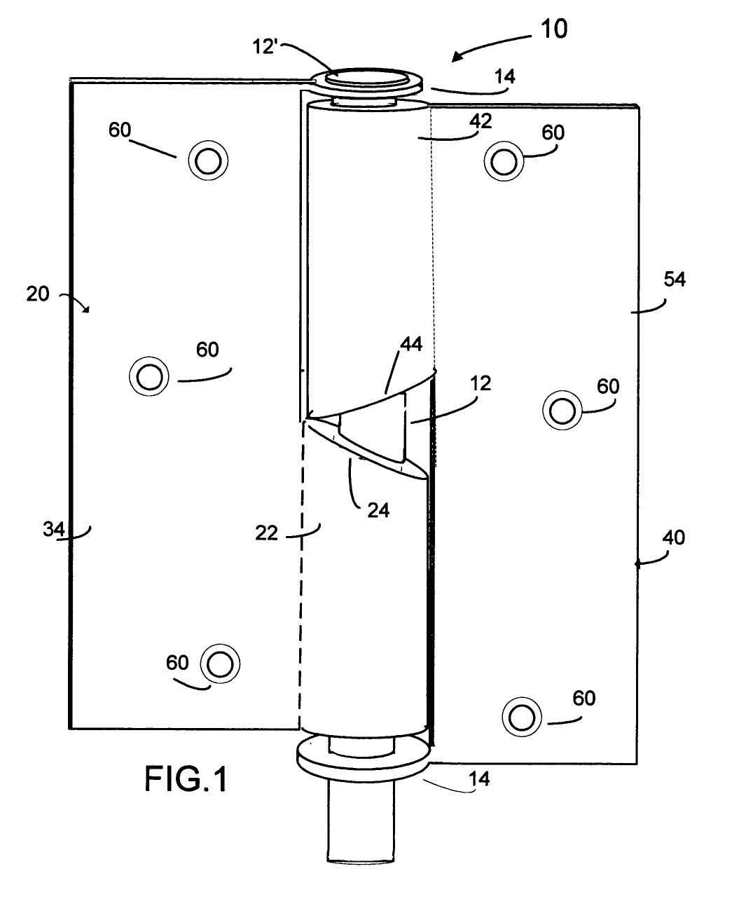

FIG. 1 shows a self-closing hinge system according to an exemplary embodiment, generally at 10. System 10 typically includes a first leaf member 20, which is rotationally coupled to a second leaf member 40. System 10 may include a shaft 12 that extends between the leaf members such that the members remain rotationally coupled. First leaf member 20 typically includes a first cylinder portion 22 and a first oblique edge 24. First cylinder portion 22 is typically configured to extend around shaft 12.

Second leaf member 40 typically includes a second cylinder portion 42 and a second oblique edge 44. Again, the cylinder portion is configured to extend around shaft 12 such that first leaf member 20 and second leaf member 40 are rotationally coupled. Second oblique edge 44 may abut first oblique edge 24 such that when a horizontal force is exerted on either member that horizontal force is translated into a horizontal and vertical force such that one member moves vertically with respect to the other member. With this configuration, it will be appreciated that the hinge may be self-closing in that when it is open, as shown in FIG. 1, a gravitational force will act upon it and the vertical gravitational force will be translated into a vertical and horizontal component such that the one member will move horizontally with respect to the other, and also move vertically with respect to the other.

First leaf member 20 may also include a door coupling portion 34 configured to couple to a door or a frame as desired. Similarly, second leaf member 40 typically includes a frame coupling portion 54 which is configured to couple to a door or a frame as desired. With one member attached to a door and the other member attached to a frame, this configuration would allow for a self-closing hinge and door.

System 10 also typically includes one or more stops 14 that are typically coupled to shaft 12 such that the leaf members will remain coupled to shaft 12. Shaft 12 is typically a pin used in a door hinge, however it may be integrally formed with either leaf member or other configuration, as desired. The hinge is typically made of a rigid material such as a metal, however other materials may be utilized, as desired.

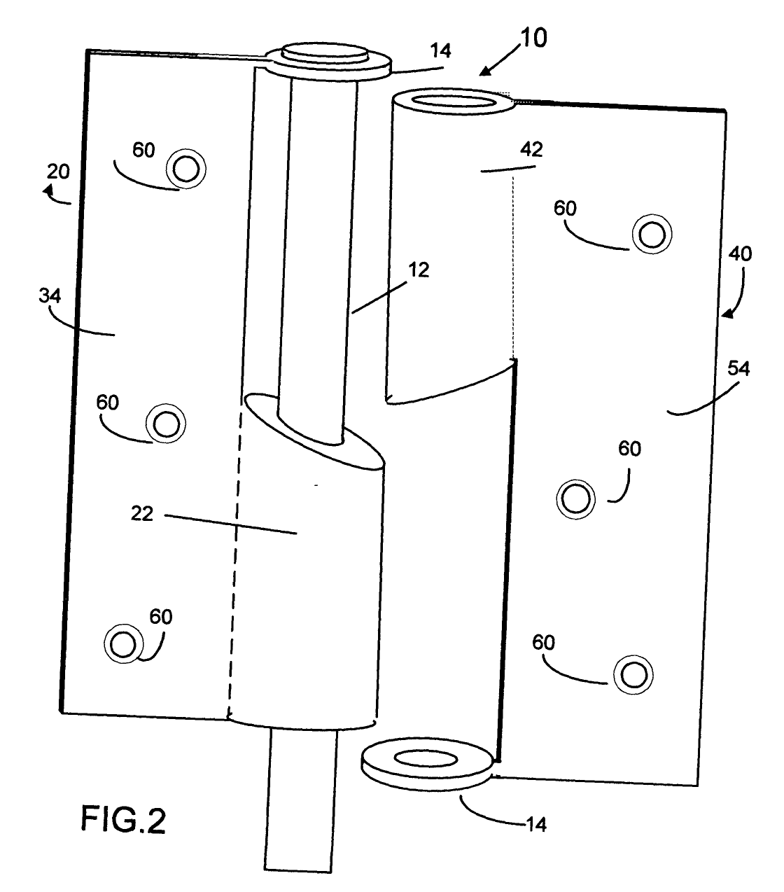

FIG. 2 shows a perspective view of the exemplary embodiment in FIG. 1, with second leaf member 40 decoupled from shaft 12 and first leaf member 20. It will be appreciated that when the members are rotated with respect to each other one member will move in the vertical direction with respect to the other. First oblique edge 24 and second oblique edge 44 typically abut each other and may be lubricated with oil, graphite or other lubrication materials. It will be appreciated that bushings may also be utilized such that when they wear out they can easily be replaced, to extend the life of the hinge. Similarly, stops 14 may also include bushings and/or lubrication or other materials to extend the life of the hinge, such that they will not wear out quickly.

Leaf members typically include apertures 60 that are typically configured to receive screws therethrough to couple a door or a frame to each of the leaf members. It will be appreciated however that other coupling configurations and methods may be utilized, as desired.

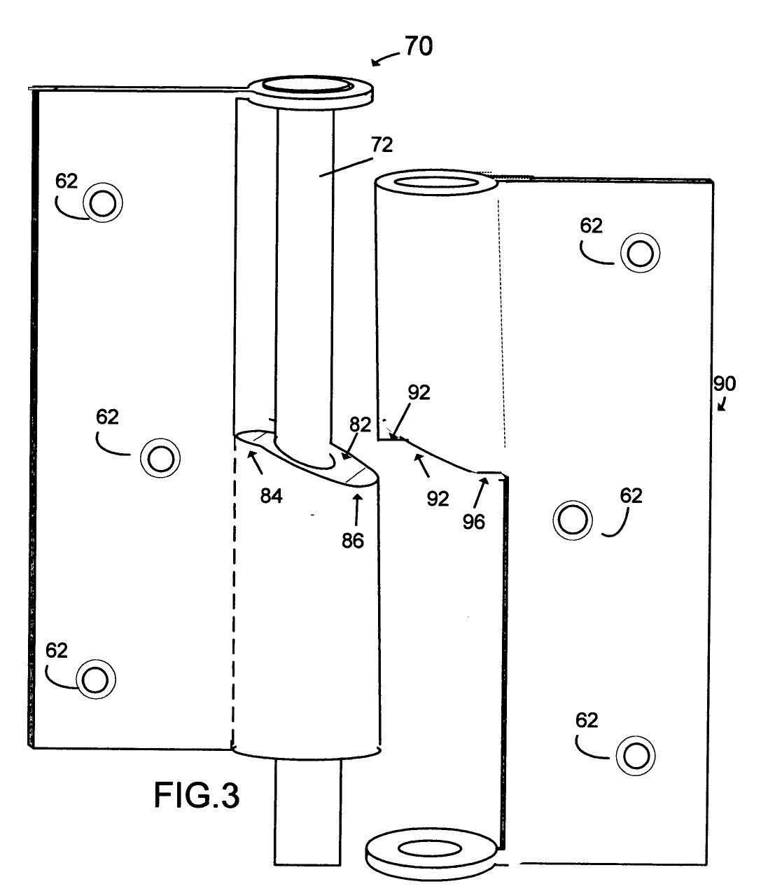

FIG. 3 shows another exemplary embodiment of a self-closing hinge system generally at 70. System 70 again typically includes a first leaf member 80 and a second leaf member 90 that are configured to rotationally couple together. System 70 also typically includes a shaft 72 that couples to both leaf members such that they are rotationally coupled together.

In this exemplary embodiment, first leaf member 80 again includes a first oblique edge 82 and also includes a top stay 84 and a bottom stay 86. Similarly, second leaf member 40 includes a second oblique edge 92 as well as a top stay 94 and a bottom stay 96. With this configuration when the door is in the open position, the top stay portions will abut each other such that the hinge may remain in the open position until acted upon by a horizontal force such that oblique edges will abut each other and the hinge may move toward a closed position and one member will move vertically with respect to the other. Also with this configuration, with top stays abutting each other, the force may be reduced on shaft 72 such that the shaft could be removed easily and/or the system may easily be disassembled.

Similarly when bottom stays 86 and 96 abut each other, the door will remain in a closed position until acted upon by a horizontal force. In this configuration also the forces may be reduced on shaft 72 such that it may be removed from the system easily. This configuration would allow a person to easily remove the shaft and thus be able to decouple the leaf members and remove a door from a frame very easily.

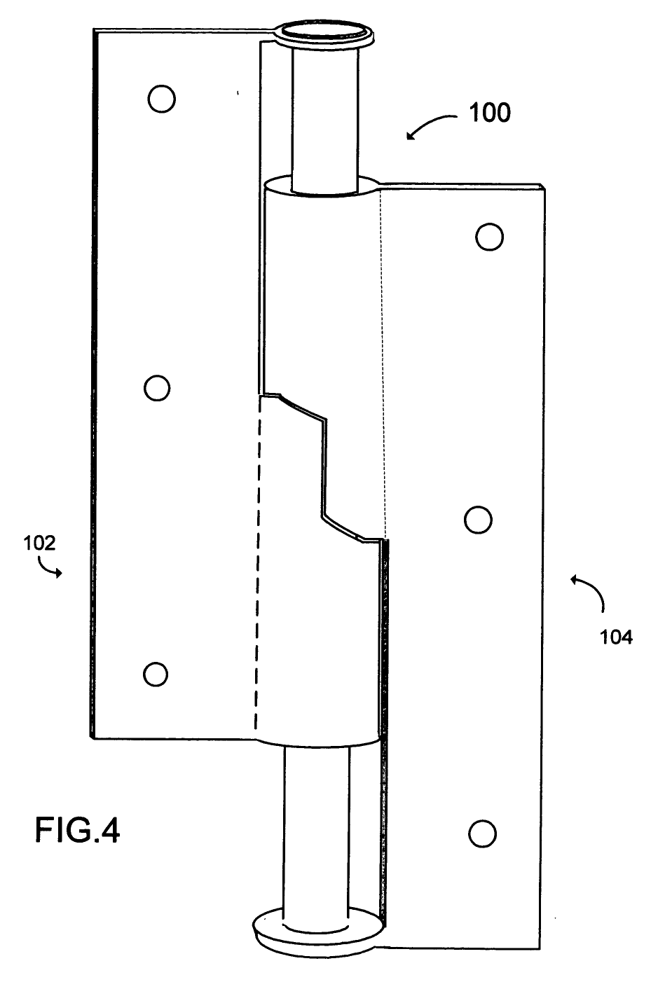

FIG. 4 shows yet another embodiment of the present invention generally at 100. System 100 again typically includes leaf members 102 and 106, but also include vertical edge, such that one leaf must be moved vertically before a horizontal force may act upon it to open the hinge.

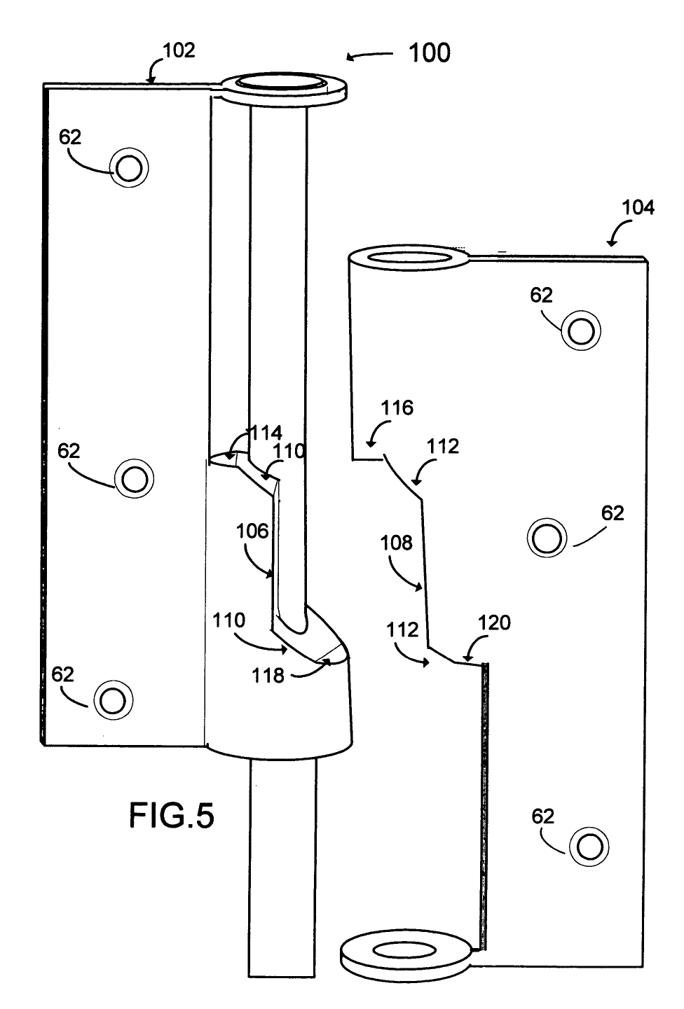

FIG. 5 shows the exemplary embodiment of FIG. 4 with the second leaf member not coupled to the system. System 100 includes a first leaf member 102 and a second leaf member 104 that both include a vertical portion 106 and 108 respectively. With this configuration, a door or one of the members would have to be lifted or moved vertically such that the oblique portions abut each other to allow the hinge and, consequently, a door to be opened. This may be useful for child safety as well as used with animals, and the like. Again, system 100 includes oblique edges 110 and 112 and upper stops 114 and 116, and lower stops 118 and 120 such that the hinge will remain in an open position when the top stays are abutting each other and would remain closed when the bottom stays are abutting each other.

Again, the system 100 may typically include apertures 62 that are configured to allow a screw to pass therethrough to couple a door, frame, or the like, to the hinge system. This system is simple, inexpensive, easy to assemble and disassemble, and still provides a self-closing system for doors and the like. It will be appreciated that a door may have to move vertically with respect to a frame for this system to operate. The frame configuration and size may have to be adjusted to allow for this, and faciaboard or other could be placed across the gap above or below the door to minimize the gap or visual gap, as desired.

In closing, it is to be understood that the exemplary embodiments described herein are illustrative of the principles of the present invention. Other modifications that may be employed are within the scope of the invention. Thus, by way of example, but not of limitation, alternative configurations may be utilized in accordance with the teachings herein. Accordingly, the drawings and description are illustrative and not meant to be a limitation thereof.

1. A self-closing hinge system, comprising:
a shaft;
a first leaf member rotationally coupled to said shaft; and
a second leaf member rotationally coupled to said shaft;
wherein said first and second members each include an oblique edge abutting the other oblique edge, such that a horizontal force on the two members is translated into a horizontal and vertical force; and
wherein said vertical force moves one member vertically with respect to the other member.

2. The self-closing hinge system of claim 1, further comprising one or more stays coupled to said shaft to secure said first and second leaf members to said shaft.

3. The self-closing hinge system of claim 1, further comprising a door coupled to one of said members, and a frame coupled to the other said member.

4. The self-closing hinge system of claim 1, wherein said first leaf member comprises:
a first cylindrical portion; and
a door coupling portion adjacent to, and coupled to, said first cylindrical portion.

5. The self-closing hinge system of claim 4, wherein said first leaf member further comprises:
a top stay edge adjacent to said oblique edge; and
a bottom stay edge adjacent to said oblique edge.

6. The self-closing hinge system of claim 4, wherein said first leaf member further comprises a generally vertical edge adjacent said oblique edge.

7. The self-closing hinge system of claim 1, wherein said second leaf member comprises:
a second cylindrical portion; and
a frame coupling portion adjacent to, and coupled to, said second cylindrical portion.

8. The self-closing hinge system of claim 7, wherein said second leaf member further comprises:
a top stay edge adjacent to said oblique edge; and
a bottom stay edge adjacent to said oblique edge.

9. The self-closing hinge system of claim 7, wherein said second leaf member further comprises a generally vertical edge adjacent said oblique edge.

10. A self-closing hinge system, comprising:
a first member; and
a second member rotationally coupled to said first member;
wherein said first and second members each include an oblique edge abutting each other, such that a horizontal force on one of the members is translated into a horizontal and vertical force.

11. The self-closing hinge system of claim 10, further comprising a shaft coupled to said first and second members.

12. The self-closing hinge system of claim 10, further comprising one or more stops adjacent to said shaft.

13. The self-closing hinge system of claim 10, wherein said vertical force moves one member vertically with respect to the other member.

14. The self-closing hinge system of claim 10, wherein the force of gravity is translated into a vertical and horizontal force such said first or second leaf member returns to a closed position.

15. The self-closing hinge system of claim 10, further comprising a door coupled to one of said members, and a frame coupled to the other said member.

16. A self-closing hinge system, comprising:
a first leaf member; and
a second leaf member rotationally coupled to said first leaf member;
wherein said first and second members are configured such that a horizontal force on one of the members is transformed into a horizontal and vertical force, wherein said vertical force raises one member with respect to the other member.

17. The self-closing hinge system of claim 16, further comprising a shaft coupled to said first and second members.

18. The self-closing hinge system of claim 16, wherein said members are configured to couple to at least one of a door and a frame.
